(19) United States
(12) Patent Application Publication
(10) Pub. No.: US 2006/0056718 A1
(43) Pub. Date: Mar. 16, 2006

(54) Method, device and computer program for encoding digital image

(76) Inventor: Heige Simula, Kemi (FI)

Correspondence Address: YOUNG & THOMPSON, 745 SOUTH 23RD STREET, 2ND FLOOR, ARLINGTON, VA, 22202, US

(21) Appl. No.: 10/542,349

(22) PCT Filed: Jan. 14, 2004
(86) PCT No.: PCT/FI04/00019

§ 371 Date: Jul. 14, 2005

(30) Foreign Application Priority Data
Jan. 14, 2003 (FI) 20030051

(51) Int. Cl. G06K 9/36

(52) U.S. Cl. 382/239

(57) ABSTRACT

The invention relates to a method, device, and computer program on a carrier for encoding a digital image. Until the encoded image fits into a desired amount of data, the method repeats: encoding the image into an encoded image, the encoding comprising quantizing causing lossy compression; decoding the encoded image into an image, the decoding comprising inverse quantizing; and increasing the losses in compression caused by the quantizing.

### FIELD

The invention relates to a method for encoding a digital image, a device for encoding a digital image, and a computer program on a carrier for encoding a digital image.

### BACKGROUND

Several different techniques are known for encoding a digital image, either one image or consecutive images. Examples of these include techniques according to different standards, such as JPEG (Joint Photographic Experts Group) and MPEG (Moving Picture Experts Group) with their various versions and modifications.

When the density of the compression provided by encoding becomes high enough, varying disturbances, especially segmentation, begin to occur in an image encoded according to the prior art solutions. Segmentation usually shows in the image as quantizing squares. Therefore, there is a great need to provide better than before encoding methods, in which the quality of the image remains good even at high compression densities.

### BRIEF DESCRIPTION

It is an object of the invention to provide an improved method for encoding a digital image, an improved device for encoding a digital image, and an improved computer program on a carrier for encoding a digital image.

As one aspect of the invention, a method for encoding a digital image is presented. Until the encoded image fits into the desired amount of data, the method repeats: encoding the image into an encoded image, the encoding comprising quantizing causing lossy compression; decoding the encoded image into an image, the decoding comprising inverse quantizing; and increasing the losses in compression caused by the quantizing.

As one aspect of the invention, a device for encoding a digital image is presented. The device comprises an encoder for encoding an image into an encoded image, the encoder comprising a quantizer for performing quantizing causing lossy compression; a decoder for decoding the encoded image into an image, the decoder comprising an inverse quantizer for performing inverse quantizing; and the encoder has a feedback connection through the decoder to the encoder; and the device is configured to repeat the encoding until the encoded image fits the desired amount of data by encoding the image with the encoder into an encoded image, decoding the encoded image with the decoder into an image, and increasing, during each feedback, the losses in compression caused by the quantizing in the quantizer.

As one aspect of the invention, a computer program on a carrier is presented for encoding a digital image. The computer program comprises commands to be executed in a computer that, until the encoded image fits into the desired amount of data, make the computer repeat: encoding the image into an encoded image, the encoding comprising quantizing causing lossy compression; decoding the encoded image into an image, the decoding comprising inverse quantizing; and increasing the losses in compression caused by the quantizing.

Preferred embodiments of the invention are described in the dependent claims.

The invention is based on the idea that the image is not encoded into its final form in one encoding using quantizing of the required magnitude, but there are several encoding times. Decoding is performed between the encoding times and the losses in compression caused by the used quantizing are increased in the next encoding time.

The procedure of the invention provides several advantages. With the procedure, it is possible to compress an image with a much higher compression density than when using the prior-art encoding methods without substantial deterioration in the image quality. Especially segmentation is reduced significantly when using the presented procedure. In a way, the procedure replaces segmentation with a gradual dimming of the image. It is, however, considerably more pleasant to look at a slightly dim image than a clearly segmented image, especially on a small display, such as the display of a subscriber terminal of a radio system. A great advantage is that an image encoded according to the procedure can be decoded with an ordinary decoder that requires no changes on account of the procedure. The decoder does not even need to know that the encoded image is encoded using the new type of encoding of the procedure.

### LIST OF FIGURES

The invention will now be described in greater detail by means of the preferred embodiments and with reference to the attached drawings, in which

FIG. 1 is a simplified block diagram illustrating a device for encoding a digital image;

FIGS. 2 and 3 show examples of the use of a device for encoding a digital image; and

FIG. 4 is a flow chart illustrating a method for encoding a digital image.

### DESCRIPTION OF EMBODIMENTS

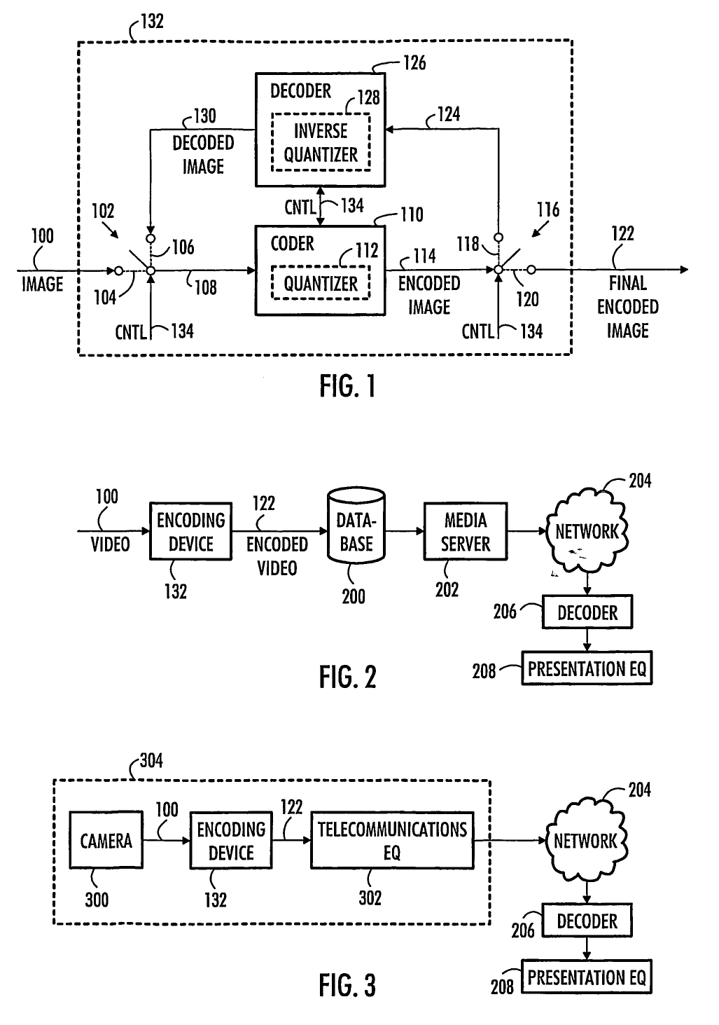

With reference to FIG. 1, a device 132 for encoding a digital image is described. With the device 132, it is possible to encode individual digital images and also consecutive digital images that form a moving image. The description is simplified, since, for a person skilled in the art, encoding a digital image is well known on the basis of standards and textbooks. For instance, it is possible to read about the JPEG standard on the home pages of the JPEG organization (when this was written, the address was http://www.jpeg.org/), and the MPEG standard on the home pages of the MPEG organization (when this was written, the address was http://mpeg.teleocmitalialab.com/). Further information on an encoder according to the MPEG4 standard and its implementation can be found in U.S. Pat. No. 5,760,836, which is incorporated herein by reference.

An image 100 can be formed with a camera, for instance a digital camera or a digital video camera. In a digital camera or video camera, the objective directs light not to a film, but to an image sensor, which can be called a CCD (Charge-Coupled Device) cell. Each electrode in a CCD cell stores one picture element, i.e. pixel. A typical number of pixels in one image may vary from a few hundred thousands to millions, even tens of millions as the technology advances.

Naturally, the image 100 can already have been formed quite a long time before it is fed into the device 132. In such a case, the image 100 can have been stored onto a storage medium, such as the tape of a VHS (Video Homing System) video recorder, DVD (Digital Versatile Disc), CD-ROM (Compact Disc Read Only memory), hard disk of a computer, memory of a subscriber terminal of a radio system, or some other storage medium, for example a memory circuit. The image 100 can also be received over a telecommunications connection, such as the radio interface of a radio system or the Internet.

The image 100 is brought to the device 132. A switch 102 is then set into position 104 with a control signal 134, after which the image 100 is taken to an input 108 of an encoder 110. The image 100 is encoded into an encoded image 114 in the encoder 110. The encoder 110 contains a quantizer 112 for performing quantizing causing lossy compression.

There are many different used image sizes, for instance the cif size is 352×288 pixels and the qcif size is 176×144 pixels. Typically an individual image is divided into blocks of certain size. One block usually comprises information on luminance, colour, and location. Compression is based on removing the less significant data. Compression methods can be divided into three different classes: reducing spectral redundancy, reducing space redundancy, and reducing temporal redundancy. A YUV colour scheme, which is based on the fact that the human eye is more sensitive to changes in luminance, i.e. brightness, than chrominance, i.e. colour, can be used to reduce spectral redundancy. The YUV scheme has for instance one luminance component (Y) and two chrominance components (U, V). The size of a luminance block can for instance be 16×16 pixels, and the size of each chrominance block, which together cover the same area as the luminance block, can be 8×8 pixels. A combination of luminance and chrominance blocks covering the same area can be called a macro block. Each pixel in both the luminance and chrominance block may obtain a value within the range of 0 to 255, i.e. eight bits are required to display one pixel. For instance, the value 0 of a luminance pixel means black and the value 255 means white. Discrete cosine transformation (DCT) may be used to reduce space redundancy. In discrete cosine transformation, the pixel presentation of the block is transformed to a frequency range. Discrete cosine transformation is lossless transformation. Temporal redundancy can be reduced with motion compensation prediction. Consecutive images usually resemble each other, so instead of compressing each individual image, block motion data, which defines where part of the areas in the previous image moved in the next image, and error components, which define the error between the compressed and actual image, are generated.

This encoding description does not, however, go into more detail, since the device 132 being described works for both individual images and consecutive images and uses all such known encoding methods that perform, when encoding the image, quantizing causing lossy compression. Quantizing reduces the number of bits that are used in encoding the values of different frequency ranges. The human eye is less sensitive to higher frequencies, so they can be quantized more. Quantizing can be implemented for instance by dividing DCT coefficients by a specific quantizing parameter so that less significant bits disappear from each DCT coefficient. The quantizing parameter may vary for each macro block. The more often the quantized DCT coefficients obtain the value 0, the better the compression. Quantized DCT coefficients, motion vectors, and quantizing parameters are then encoded using run-length coding and variable-length coding, such as Huffman coding. Quantizing is the only lossy compression in encoding excluding sub-sampling.

The device 132 not only comprises the encoder 110, but also a decoder 126 for decoding the encoded image 114 back to an image 130. The encoder 110 has a feedback connection through the decoder 126 to the encoder 110. A switch 116 is set into position 118 with the control signal 134, after which the encoded image 114 is taken to an input 124 of the decoder. The decoder 126 contains an inverse quantizer 128 for inverse quantizing. Inverse quantizing removes the quantizing 112 done in the quantizer. The effects of quantizing cannot, however, completely be removed by inverse quantizing, and this is the reason for losses in quantizing.

With the control signal 134, the switch 102 is set into position 106, after which the image 130 obtained from the decoder 126 is taken to the input 108 of the encoder 110. The control signals 134 also control the operation of the encoder 110 and decoder 126, and, therefore, of course also the operation of the quantizer 112 and inverse quantizer 128.

The device 132 is configured to repeat encoding until the encoded image 114 fits into the desired amount of data. The repetition is done in the described manner by encoding the image 100 into an encoded image 114 with the encoder 110, decoding the encoded image 114 into an image 130 with the decoder 126, and increasing with every feedback the losses in compression caused by quantizing in the quantizer 112. When the encoded image 114 fits into the desired amount of data, the switch 116 is directed to position 120 with the control signal 134, after which the final encoded image is obtained from the output 122 of the device and can for instance be stored onto a storage medium or transmitted over a data transmission link to a recipient. The device 132 is configured to define the desired amount of data for instance as the size of the file used for storing the encoded image 114, or as the bandwidth of the data transmission link used for transmitting the encoded image 114, or as the compression density of the encoded image 114.

After this, the switch 102 is set to position 104 with the control signal 134, and the system is ready to receive the next image 100 for processing.

When the encoded image needs to be viewed, it is decoded with a suitable decoder. The encoded image can be decoded with an ordinary decoder that requires no changes on account of the method. The decoder does not even need to know that the encoded image is encoded using the new type of encoding of the method. Thus, the encoding can be done with any prior-art encoding with the gradual quantizing described above, and the decoding can be done with normal, prior-art decoding designed for the encoding.

The example of FIG. 1 describes in a simple manner the operation required for encoding an individual image 100. When encoding a moving image 100 formed by consecutive images, the principle is the same, but the motion compensation performed to reduce temporal redundancy requires changes to this basic structure, in accordance with U.S. Pat. No. 5,760,836, FIG. 1, incorporated herein by reference.

The encoding device for digital images described in FIG. 1 can be used in all applications in which a conventional prior-art encoding device can be used. A decoding device can also be connected to the encoding device, in which case the device can be called an image codec.

FIGS. 2 and 3 show examples of the use of an encoding device for digital images.

In FIG. 2, a video image 100 is encoded with the encoding device 132, and the encoded video 122 is stored in a database 200. A media server 202 fetches the encoded video from the database 200 and transmits it through a data transmission network 204 to a recipient that has a decoder 206 for decoding the received encoded video and presentation equipment 208 for displaying it. The presentation equipment 208 generally comprises a display for displaying the image and a loudspeaker for reproducing sound. In the manner shown in FIG. 2, it is for instance possible to encode television programmes and transmit them to a television receiver 208 that contains a decoder 206. The data transmission network 204 can then at least partly be made up of a cable television network. In the manner shown in FIG. 2, it is also possible to encode television programmes and transmit them to a subscriber terminal 208 that contains a decoder 206. The data transmission network 204 is then at least partly made up of a radio system. The transmission of an encoded image in a radio system can be packet-switched or circuit-switched. The radio system can for instance be GSM (Global System for Mobile Communications), which possibly uses GPRS (General Packet Radio System) for packet-switched data transmission to the subscriber terminal. The embodiments are, however, not limited to this radio system used as an example, but a person skilled in the art can also apply the teachings to other radio systems that support data transmission to the subscriber terminal, such as UMTS (Universal Mobile Telecommunications System). FIG. 2 also shows an embodiment, in which video programmes, such as films, stored on DVD, for instance, are stored in the database 200, and the media server 202 then implements a video hire system operating over the data transmission network 204, such as the Internet. The videos to be hired are then encoded in the described manner, and the customer selects the desired film from the media server 202 and the film is transmitted in the encoded form over the data transmission network 204 to the viewer's terminal 208 that contains a decoder 206, for instance television, computer, or subscriber terminal of a radio system.

In FIG. 3, the encoding device 132 is placed in the subscriber terminal 304 of a radio system, for instance in a mobile phone that can be similar to Nokia® 7650 that contains a digital camera. The mobile phone also has telecommunications equipment 302, i.e. in practice a transceiver for transmitting encoded images through the radio system 204 to other devices that contain a decoder 206 and presentation equipment 208. The device 304 shown in FIG. 3 can also be a computer with a digital camera 300 and data transmission equipment 302. The data transmission network 204 can then be the Internet, for instance.

In one embodiment, the quantizer 112 is configured, for the purpose of optimizing the quality of the encoded image, to increase the losses in compression caused by quantizing in such a manner that each encoding reduces the amount of data required by the encoded image by ¼ to 1/100 of the amount of data required originally. This embodiment can be used especially when the encoded image need not be transmitted in real time and there is enough time available for encoding it. For instance, let us assume that if 4, megabits/second was needed to transmit the original moving image in real time, and the final encoded image needs to be transmitted at a rate of 500 kilobits/second, then during each encoding cycle, the required bandwidth could be decreased by 100 kilobits/second, for instance. This way, the decrease would be 1/40 of the originally required bandwidth during each encoding cycle. Thus, 35 encoding cycles would be needed. For instance, when wishing to implement the video hire system described in FIG. 2, the quality of the image could be optimized by encoding performed in advance, even though the encoding was slow per se: it only needs to be done once for each film before the film is stored in the database 200.

In one embodiment, the quantizer 112 is configured, for the purpose of speeding up encoding, to increase the losses in compression caused by quantizing initially in such a manner that each encoding reduces the amount of data required by the encoded image by ½ to ¼ of the amount of data required originally, and at the end of encoding in such a manner that each encoding reduces the amount of data required by the encoded image by ¼ to 1/100 of the amount of data required originally. This embodiment can be used when the image needs to be transmitted almost in real time, for instance by using the subscriber terminal 304 containing a digital camera described in FIG. 3. For instance, if the real-time data transmission of the original moving image required 4 megabits/second, and the final encoded image needed to be transmitted at a rate of 36 kilobits/second, for example, then the decrease in bandwidth could be performed as follows: 4 megabits/second→2 mega-bits/second→1 megabit/second→500 kilobits/second→400 kilobits/second→300 kilobits/second→200 kilobits/second→100 kilobits/second→72 kilo-bits/second→36 kilobits/second. Thus, nine encoding cycles would be needed.

When even faster encoding is required, the quantizer 112 can be configured, for the purpose of speeding up encoding, to increase the losses in compression caused by quantizing in such a manner that the first encoding reduces the amount of data required by the encoded image by half of the amount of data required originally, and each of the following encodings halves the amount of data required by the encoded image. For instance, if 4,096 kilobits/second were needed to transmit the original moving image in real time, and the final encoded image needed to be transmitted at a rate of 32 kilobits/second, for example, then the decrease in bandwidth could be performed as follows: 4,096 kilobits/second→2,048 kilobits/second→1,024 kilo-bits/second→512 kilobits/second→256 kilobits/second→128 kilo-bits/second→64 kilobits/second→32 kilobits/second. Thus, seven encoding cycles would be needed.

Depending on the application and conditions, it is naturally also possible to use other methods of increasing the losses in compression caused by quantizing during different cycles. The roughest bandwidth reduction is done in three cycles: original bandwidth→4,000 to 3,000 kilo-bits/second→2,000 to 1,000 kilobits/second→500 to 200 kilobits/second.

The device for encoding a digital image described in FIGS. 1, 2 and 3 can be integrated into different devices, it can be part of a digital camera, digital video camera, subscriber terminal of a radio system, personal computer, portable computer, or server. All these devices can be thought to contain an electronic digital computer that contains the following main parts: central processing unit (CPU), working memory, and system clock. In addition, it is possible to connect to the computer various peripherals, such as display, keyboard, sound card with loudspeakers, and data storage unit. The central processing unit comprises three main parts: registers, arithmetic-logic unit (ALU), and control unit. The data structures and software required by processing are implemented by different programming languages. The above-mentioned configuration can be implemented by programming, i.e. by creating software and data structures that contain the required functionality, but pure hardware solutions are also possible, for example a circuit built up of separate logic components or one or more application-specific integrated circuits (ASIC). A hybrid of these implementations is also possible. In selecting the implementation method, a person skilled in the art takes into consideration the requirements set on the size and power consumption of the device, the required processing power, manufacturing costs and-production quantities.

The computer program required to configure the device can be placed on a carrier. The computer program comprises commands to be executed on the computer that, until the encoded image fits the desired amount of data, make the computer repeat: encoding the image into an encoded image, the encoding including quantizing that causes lossy compression; decoding the encoded image into an image, the decoding including inverse quantizing; and increasing the losses in compression caused by quantizing. The carrier can be any prior-art method for distributing the computer program to a client. The carrier comprises at least one of the following: computer memory, computer-readable memory, telecommunications signal, file used to distribute a computer program.

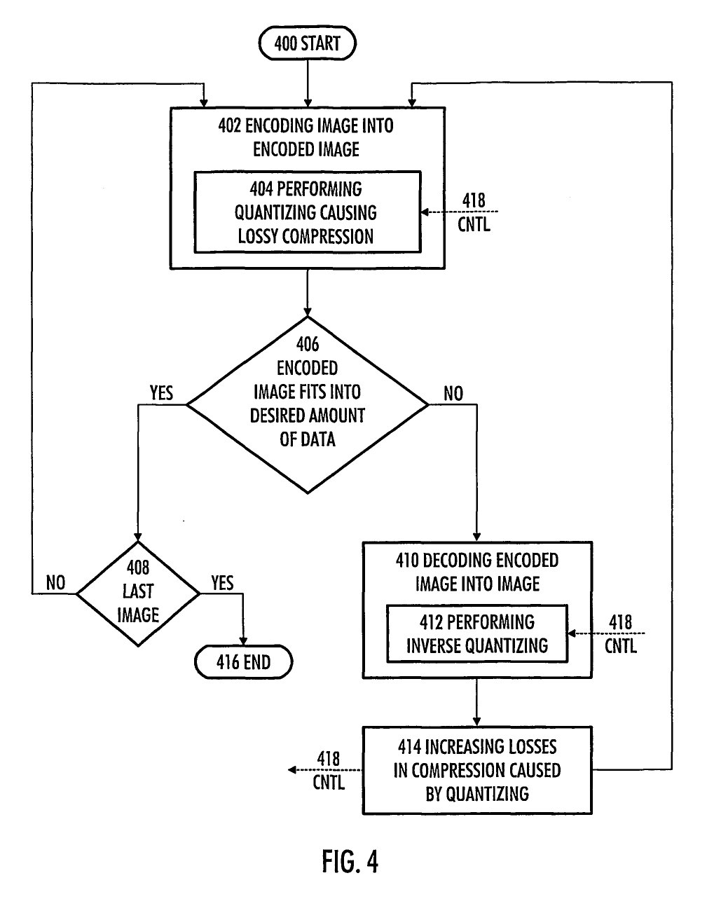

In the following, a method for encoding a digital image is described with reference to FIG. 4. The execution of the method starts in step 400.

Until the encoded image fits into the desired amount of data, the following is repeated: in 402, encoding the image into an encoded image, the encoding including quantizing causing lossy compression in 404, decoding in 410 the encoded image into an image, the decoding including inverse quantizing in 412, and increasing in 414 the losses in compression caused by quantizing. Thus, a loop 402-410-414 is formed and it is repeated until in 402, the image resulting from encoding fits into the desired amount of data. The desired amount of data can be defined before starting encoding, or it can even be dynamically changed, if necessary. Dynamic change is necessary for instance when the data transmission rate of the telecommunications connection used in transmitting an encoded video image changes during the transmission. Control signals 418 show that there is a specific relationship between quantizing and inverse quantizing: quantizing of a certain magnitude is removed using inverse quantizing of the same magnitude.

In the example of FIG. 4, the loop is implemented in such a manner that in 406, the fit of the image into the desired amount of data is checked. If the image fits into the desired amount of data, the process moves to 408, which checks whether this is the last image: if the image is the last one, the process moves to 416, in which the execution of the method is stopped, otherwise, the process moves to 402, in which the encoding of the next image is started. If the encoded image does not fit into the desired amount of data, the process moves from 406 to 410 for decoding and then to 414 for increasing the losses in compression caused by quantizing, then the process moves from 414 to 402 to start the next encoding cycle. The method can be modified using the embodiments described above. The method can be implemented by the device described in connection with FIGS. 1, 2 and 3, but a device of different type may also be applicable for executing the method, if in it, it is possible to adjust the losses in compression caused by quantizing and to perform decoding as described above.

Even though the invention has been explained in the above with reference to an example in accordance with the accompanying drawings, it is apparent that the invention is not restricted to it but can be modified in many ways within the scope of the inventive idea disclosed in the attached claims.

1-16. (canceled)

17. A method for encoding a digital image, wherein, until the encoded image fits into the desired amount of data, the method repeats:
encoding the image into an encoded image, the encoding comprising quantizing causing lossy compression;
decoding the encoded image into an image, the decoding comprising inverse quantizing; and
increasing the losses in compression caused by the quantizing.

18. A method as claimed in claim 17, wherein, for the purpose of optimizing the quality of the encoded image, the losses in compression caused by quantizing are increased in such a manner that each encoding reduces the amount of data required by the encoded image by ¼ to 1/100 of the amount of data required originally.

19. A method as claimed in claim 17, wherein, for the purpose of speeding up encoding, the losses in compression caused by quantizing are initially increased in such a manner that each encoding reduces the amount of data required by the encoded image by ½ to ¼ of the amount of data required originally, and at the end of encoding in such a manner that each encoding reduces the amount of data required by the encoded image by ¼ to 1/100 of the amount of data required originally.

20. A method as claimed in claim 17, wherein, for the purpose of speeding up encoding, the losses in compression caused by quantizing are increased in such a manner that the first encoding reduces the amount of data required by the encoded image by half of the amount of data required originally, and each of the following encodings halves the amount of data required by the encoded image.

21. A method as claimed in claim 17, wherein the desired amount of data is defined as the size of the file used for storing the encoded image, or as the bandwidth of the data transmission link used for transmitting the encoded image, or as the compression density of the encoded image.

22. A device for encoding a digital image, comprising: an encoder for encoding an image into an encoded image, the encoder comprising a quantizer for performing the quantizing causing lossy compression;
a decoder for decoding the encoded image into an image, the decoder comprising a inverse quantizer for performing inverse quantizing; and
the encoder has a feedback connection through the decoder to the encoder; and
the device is configured to repeat the encoding until the encoded image fits into the desired amount of data by encoding the image with the encoder into an encoded image, decoding the encoded image with the decoder into an image, and increasing, during each feedback, the losses in compression caused by the quantizing in the quantizer.

23. A device as claimed in claim 22, wherein the quantizer is configured, for the purpose of optimizing the quality of the encoded image, to increase the losses in compression caused by quantizing in such a manner that each encoding reduces the amount of data required by the encoded image by ¼ to 1/100 of the amount of data required originally.

24. A device as claimed in claim 22, wherein the quantizer is configured, for the purpose of speeding up encoding, to increase the losses in compression caused by quantizing initially in such a manner that each encoding reduces the amount of data required by the encoded image by ½ to ¼ of the amount of data required originally, and at the end of encoding in such a manner that each encoding reduces the amount of data required by the encoded image by ¼ to 1/100 of the amount of data required originally.

25. A device as claimed in claim 22, wherein the quantizer is configured, for the purpose of speeding up encoding, to increase the losses in compression caused by quantizing initially in such a manner that the first encoding reduces the amount of data required by the encoded image by half of the amount of data required originally, and each of the following encodings halves the amount of data required by the encoded image.

26. A device as claimed in claim 22, wherein the device is configured to define the desired amount of data as the size of the file used for storing the encoded image, or as the bandwidth of the data transmission link used for transmitting the encoded image, or as the compression density of the encoded image.

27. A computer program on a carrier for encoding a digital image, comprising commands to be executed in a computer that, until the encoded image fits into the desired amount of data, make the computer repeat:
encoding the image into an encoded image, the encoding comprising quantizing causing lossy compression;
decoding the encoded image into an image, the decoding comprising inverse quantizing; and
increasing the losses in compression caused by the quantizing.

28. A computer program as claimed in claim 27, wherein, for the purpose of optimizing the quality of the encoded image, the losses in compression caused by quantizing are increased in such a manner that each encoding reduces the amount of data required by the encoded image by ¼ to 1/100 of the amount of data required originally.

29. A computer program as claimed in claim 27, wherein, for the purpose of speeding up encoding, the losses in compression caused by quantizing are initially increased in such a manner that each encoding reduces the amount of data required by the encoded image by ½ to ¼ of the amount of data required originally, and at the end of encoding in such a manner that each encoding reduces the amount of data required by the encoded image by ¼ to 1/100 of the amount of data required originally.

30. A computer program as claimed in claim 27, wherein, for the purpose of speeding up encoding, the losses in compression caused by quantizing are increased in such a manner that the first encoding reduces the amount of data required by the encoded image by half of the amount of data required originally, and each of the following encodings halves the amount of data required by the encoded image.

31. A computer program as claimed in claim 27, wherein the desired amount of data is defined as the size of the file used for storing the encoded image, or as the bandwidth of the data transmission link used for transmitting the encoded image, or as the compression density of the encoded image.

32. A computer program as claimed in claim 27, wherein the carrier comprises at least one of the following: computer memory, computer-readable memory, telecommunications signal, file used to distribute a computer program.

33. A device for encoding a digital image, comprising:
encoding means for encoding an image into an encoded image, the encoding means comprising quantizing means for performing the quantizing causing lossy compression;
decoding means for decoding the encoded image into an image, the decoding means comprising inverse quantizing means for performing inverse quantizing; and
the encoding means has a feedback connection through the decoding means to the encoding means; and
the device repeats the encoding until the encoded image fits into the desired amount of data by encoding the image with the encoding means into an encoded image, decoding the encoded image with the decoding means into an image, and increasing, during each feedback, the losses in compression caused by the quantizing in the quantizing means.
